(19) United States
(12) Patent Application Publication
(10) Pub. No.: US 2011/0031716 A1
(43) Pub. Date: Feb. 10, 2011

(54) Tricycle and Steering Mechanism Therefor

(76) Inventor: Luther TAYLOR, Richmond Hill (CA)

Correspondence Address: LANG MICHENER, BROOKFIELD PLACE, P.O. BOX 747, SUITE 2500, 181 BAY STREET, TORONTO, ON, M5J 2T7, CA

(21) Appl. No.: 12/909,612

(22) Filed: Oct. 21, 2010

Related U.S. Application Data
(63) Continuation of application No. 11/753,619, filed on May 25, 2007.

(30) Foreign Application Priority Data
May 26, 2006 (CA) 2548260

(51) Int. Cl. B62K 13/00; B62M 1/02; B62K 21/12; B62K 7/02; B62K 5/06

(52) U.S. Cl. 280/259; 280/267; 280/282

(57) ABSTRACT

The present invention consists of a human-powered, wheeled vehicle, having: a) two front wheels, each of the two front wheels pivotally coupled to a frame by a pivoting mount; b) one or more rear wheels, one or more of the rear wheels coupled to a drive mechanism and operative to provide a driving force for the vehicle; and c) a steering mechanism coupled to the front wheels, the steering mechanism including a handle for steering control by a driver of the vehicle, a first linkage connecting the handle to a first one of the pivoting mounts and a second linkage connecting the first one of the pivoting mounts to a second one of the pivoting mounts.

### FIELD OF THE INVENTION

The present invention relates to the field of tricycles. In particular, it relates to a steering mechanism for use with a tricycle having two front wheels.

### BACKGROUND OF THE INVENTION

Tricycles (three-wheeled vehicles) are well-known as human-powered vehicles, although they have been eclipsed by bicycles (two-wheeled vehicles) in modern times. The market for human-powered tricycles is generally limited to tricycles for small children as precursors to bicycles, for persons with disabilities, and customized tricycles used for racing, long-distance touring and similar purposes.

A conventional tricycle is designed with a single front wheel and a pair of rear wheels. In this configuration, the front wheel is steerable and the rear wheels are driven, either singly or concurrently. An alternative configuration, often used in tricycles for small children, has an oversized steerable front wheel with attached pedals, making it a driven wheel as well, and two smaller non-driven, non-steerable rear wheels.

Unfortunately, there are several problems associated with the conventional 1-front, 2-rear tricycle design. One is the tendency for the tricycle to overturn on sharp cornering, as the center of gravity is very high relative to the location of the wheels and is positioned near the front wheel. Another is that with the paired rear wheels located behind the line-of-sight of the driver, it can be difficult to determine the width of the tricycle and navigate around obstacles and through narrow paths.

To address these and other problems, tricycles with 2 front wheels and 1 rear wheel have been designed. By implementing various types of steering mechanisms to control the two front wheels, adjustments can be made to reduce the risks of tipping during turns. Furthermore, the 2-front, 1-rear design is more easily adapted to place the driver into a recumbent position, which lowers the center of gravity. An example of a recumbent tricycle design is shown in U.S. Pat. No. 6,953,203 issued to Wilcox et al. Wilcox discloses a tricycle with two front wheels and a driven rear wheel. Each front wheel is mounted in a separate steerable fork, much like the front wheel of a conventional bicycle. The driver is in a recumbent position, locating the center of gravity closer to the ground and, in particular, closer to the axis of rotation of the wheels. While this recumbent design addresses some of the problems with conventional tricycles, the use of conventional bicycle forks fundamentally restricts the Wilcox tricycle to the recumbent design.

Another example of a modified steering mechanism for a 2-front, 1-rear tricycle is disclosed in U.S. Pat. No. 6,367,824 issued to Hayashi. The Hayashi tricycle uses a set of upper and lower linkages between the front wheels to enable them to tilt as well as turn in response to steering. The tilting of the wheels can additionally be supported by a set of shock absorbers to control the return to a vertical position and reduce the mechanical force requirements of the steering mechanism.

A similar tilt steering tricycle design is disclosed in U.S. Pat. No. 4,634,137 issued to Cocksedge. Much like Hayashi, the Cocksedge tricycle uses dual linkages to the front wheels to enable tilting of the wheels and vehicle as part of the steering response. The Cocksedge tricycle is a modified recumbent design, and uses a piston-like pedal drive system, rather than a conventional rotary pedal drive system. A similar, non-recumbent design is disclosed in U.S. Pat. No. 4,740,004 issued to McMullen. The McMullen tricycle uses a tilt steering mechanism similar to that of Cocksedge, but further includes a turning load basket mounted between the front wheels. The presence of the basket results in the use of a conventional tricycle driver position and standard rotary pedal drive mechanism.

U.S. Pat. No. 2,493,817 issued to Hare discloses a powered tricycle of the 2-front, 1-rear design which uses combination of steering rods and cardanic joints to pivot each of the front wheels, as well as the axle coupling the front wheels, for improved steering balance.

A new difficulty that arises from these past attempts to address the steering issues of 2-front, 1-rear tricycles is that the complexity of the mechanism used to provide tilt steering, or body tilt, etc. limits that usefulness of the mechanism for mass production. Additionally, in the market for children's tricycles, besides the prohibitive cost of these complex designs, the increased risk of injury to the driver from additional moving parts negates any potential use of these solutions.

Ideally, the principles and design used to overcome the steering and balance issues with tricycles should also be readily applicable to equivalent quadcycles (four-wheeled (2 front, 2 rear) vehicles) as well.

### SUMMARY OF THE INVENTION

The present invention consists of a human-powered, wheeled vehicle, comprising: a) two front wheels, each of the two front wheels pivotally coupled to a frame by a pivoting mount; b) one or more rear wheels, one or more of the rear wheels coupled to a drive mechanism and operative to provide a driving force for the vehicle; and c) a steering mechanism coupled to said front wheels, the steering mechanism including a handle for steering control by a driver of the vehicle, a first linkage connecting the handle to a first one of the pivoting mounts and a second linkage connecting the first one of the pivoting mounts to a second one of the pivoting mounts.

Preferably, the pivoting mounts are coupled to the frame by kingpins which are offset at a non-zero angle from vertical.

The drive mechanism can include a set of pedals coupled to a first gear, a second gear coupled to one of the rear wheels and an endless chain connecting the first gear and the second gear.

Also preferably, the handle is a set of handlebars which is rotated by the driver to indicate a desired direction of travel for the vehicle.

Optionally, the frame supporting the two front wheels is removable, enabling conversion of the vehicle into a bicycle by attaching a different frame with a single front wheel.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a top perspective view of a tricycle according to the present invention;

FIG. 2 is a side perspective view of the tricycle of FIG. 1;

FIG. 3 is a diagram of the front wheel turning radius for a tricycle; and

FIG. 4 is a cut-away view of the kingpin and front axle.

### DETAILED DESCRIPTION OF THE PREFERRED EMBODIMENTS

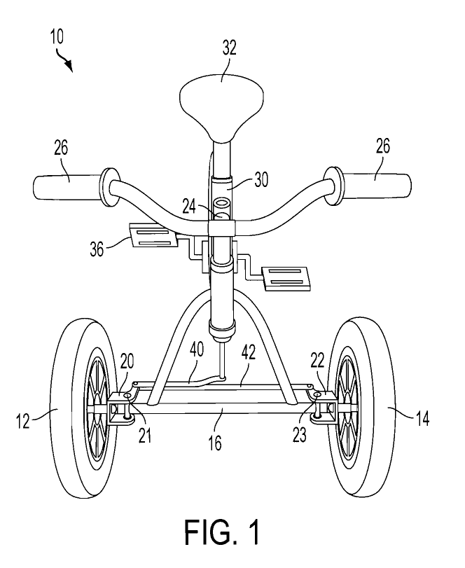

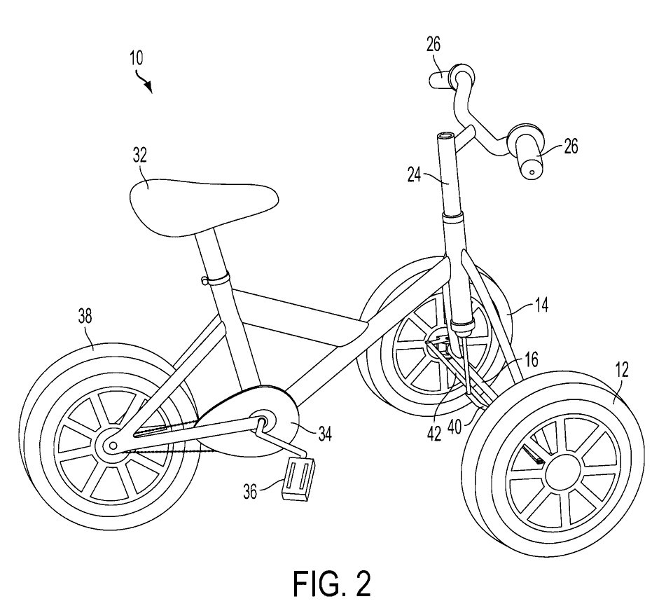

Referring now to FIG. 1 and FIG. 2, the invention in accordance with a presently preferred embodiment is indicated generally by a tricycle 10. The tricycle 10 has a pair of front wheels 12 and 14 attached to a front axle 16 by pivoting mounts 20 and 22, respectively. The front axle 16 is coupled to the frame 30. Also located at the front end of the frame 30 is a steering mechanism 24. The steering mechanism 24 has a set of handlebars 26 that can be rotated by the driver to change the direction of travel by turning the front wheels 12 and 14.

Pivoting mounts 20 and 22 are secured to the font axle 16 by kingpins 21 and 23, respectively. Preferably, kingpins 21 and 23 are positioned slightly off vertical as shown in FIG. 4. The off-vertical positioning of kingpins 21 and 23 results in front wheels 12 and 14 being re-centered if the rider releases the steering mechanism 24. This effect is derived from the weight of the rider and vehicle and will be more or less pronounced based of theses factors. The angle of the kingpins 21 and 23 is known as the Steering Axis Inclination and an angle of approximately 5 degrees has been found to produce a noticeable centering effect without impeding steering. The angle may be suitably modified depending on the design of the tricycle 10 and the anticipated weight of the rider, bearing in mind that too shallow an angle will not produce any effect, whereas too steep an angle will create interference with normal steering of the tricycle 10.

To complete the tricycle 10, a seat 32, a drive mechanism 34 powered by pedals 36 and a rear wheel 38 are all coupled to the rear end of the frame 30.

The steering mechanism 24 is connected to the pivoting mount 20 for one front wheel 12 via a rod 40. The pivoting mount 20 is connected to the other pivoting mount 22 for the other front wheel 14 by a rod 42. When the handlebars 26 are rotated, the steering mechanism 24 couples this rotation to the rod 40, moving pivoting mount 20 and causing wheel 12 to pivot around and axis perpendicular to the rotation of wheel 12 in response to the rotation of handlebars 26. Additionally, rod 42 couples pivoting mount 20 to pivoting mount 22, causing wheel 14 to pivot as well. As a result, both front wheels 12 and 14 turn in response to rotation of the handlebars 26. However, the degree of turning of the two front wheels 12 and 14 is different.

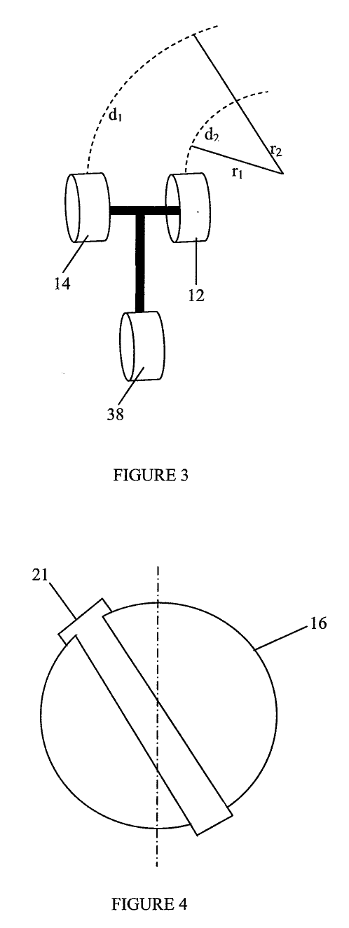

This difference is significant, as the two front wheels 12 and 14 are required to traverse different distances d1 and d2 (defined by radii r1 and r2 from the pivot point for the turn) in the course of describing an arc through a turn as shown in FIG. 3. If both wheels 12 and 14 pivoted the same amount, the wheel describing the larger arc would be subject to excessive wear, reducing the lifespan of the tires. Also, vibration effects may impede proper steering and the combination of vibration and wear could increase the risk of the vehicle tipping as the contact between the tire and the ground is decreased.

While the vehicle is shown as a tricycle, the same design can be readily adapted for a “quadcycle”—a four-wheeled vehicle (two rear wheels)—as well. In a quadcycle, one or both rear wheels are driven by the drive mechanism 34. Notably, the paired rear wheels will also be subject to the wear and vibration caused by describing unequal arcs during turning, but this is less significant when dealing with non-steering wheels. As they are non-steering wheels, the tires are subject to less wear and vibration during turning as a result of being non-steering, and the effect of describing unequal arcs is significantly less than the non-steering effect.

The two front wheels 12 and 14 are shown mounted to pivoting mounts 20 and 22 at either end of a front axle 16. However, front axle 16 does not rotate or pivot relative to the frame or the wheels. Only the front wheels 12 and 14 pivot in the turning response. By using a rigid front axle 16, the frame of the tricycle is strengthened, allow for greater balance and overall stability.

Another advantage can be created by making the frame supporting the front wheels 12 and 14 removable, preferably by using a detachable coupling located below the steering mechanism 26. The frame could then be replaced by a frame with a single front wheel, allowing conversion from a tricycle to a bicycle, to keep pace with the motor skills development of a child.

Frame 30 and pedals 36 are generally located closer to the ground in a tricycle than in a bicycle, in order to provide a lower center of gravity for the rider. Therefore, using a detachable front wheel frame as described above must be balanced against the required positioning of the main frame 30 and pedals 36.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A human-powered, wheeled vehicle, comprising:
a) first and second front wheels, each of said first and second front wheels pivotally coupled to a front axle of said frame by respective first and second pivoting mounts;
b) one or more rear wheels, one or more of said rear wheels coupled to a drive mechanism and operative to provide a driving force for said vehicle; and
c) a handle for steering control by a driver of said vehicle,
d) a first linkage connecting said handle to said first pivoting mount,
e) a second linkage connecting said first pivoting mount to said second pivoting
mount,
f) first and second kingpins for coupling said first and second pivoting mounts to said frame,
wherein said kingpins are offset from vertical by a non-zero angle, whereby when steering through a turn, one of said first and second front wheels traverses a smaller radius than the other of said first and second front wheels;
and wherein said front axle does not rotate or pivot relative to said frame or to said first and second front wheels.

2. The vehicle of claim 1, wherein said kingpins are offset from vertical by an angle of approximately 5 degrees.

3. The vehicle of claim 1, wherein said drive mechanism includes a set of pedals coupled to a first gear, a second gear coupled to one of said rear wheels and an endless chain connecting said first gear and said second gear.

4. The vehicle of claim 2, wherein said drive mechanism includes a set of pedals coupled to a first gear, a second gear coupled to one of said rear wheels and an endless chain connecting said first gear and said second gear.

5. The vehicle of claim 1, wherein said handle is a set of handlebars which is rotated by said driver to indicate a desired direction of travel for said vehicle.

6. The vehicle of claim 2, wherein said handle is a set of handlebars which is rotated by said driver to indicate a desired direction of travel for said vehicle.

7. The vehicle of claim 3, wherein said handle is a set of handlebars which is rotated by said driver to indicate a desired direction of travel for said vehicle.

8. The vehicle of claim 4, wherein said handle is a set of handlebars which is rotated by said driver to indicate a desired direction of travel for said vehicle.

9. The vehicle of claim 1, wherein said frame supporting said two front wheels is removable, enabling conversion of said vehicle into a bicycle by attaching a different frame with a single front wheel.

10. The vehicle of claim 2, wherein said frame supporting said two front wheels is removable, enabling conversion of said vehicle into a bicycle by attaching a different frame with a single front wheel.

11. The vehicle of claim 3, wherein said frame supporting said two front wheels is removable, enabling conversion of said vehicle into a bicycle by attaching a different frame with a single front wheel.

12. The vehicle of claim 4, wherein said frame supporting said two front wheels is removable, enabling conversion of said vehicle into a bicycle by attaching a different frame with a single front wheel.

13. The vehicle of claim 5, wherein said frame supporting said two front wheels is removable, enabling conversion of said vehicle into a bicycle by attaching a different frame with a single front wheel.

14. The vehicle of claim 6, wherein said frame supporting said two front wheels is removable, enabling conversion of said vehicle into a bicycle by attaching a different frame with a single front wheel.

15. The vehicle of claim 7, wherein said frame supporting said two front wheels is removable, enabling conversion of said vehicle into a bicycle by attaching a different frame with a single front wheel.

16. The vehicle of claim 8, wherein said frame supporting said two front wheels is removable, enabling conversion of said vehicle into a bicycle by attaching a different frame with a single front wheel.
